(19) United States
(12) Patent Application Publication
(10) Pub. No.: US 2026/0270051 A1
(43) Pub. Date: Sep. 10, 2026

(54) RECONFIGULRABLE LOGIC DEVICE WITH A PROGRAMMABLE SYMMETRIC KEY

(71) Applicant: Rickert-Areno Engineering, LLC, Round Rock, TX (US)

(72) Inventor: Matthew Areno, Round Rock, TX (US)

(21) Appl. No.: 19/558,303

(22) Filed: Mar. 5, 2026

Related U.S. Application Data
(60) Provisional application No. 63/767,837, filed on Mar. 6, 2025.
(60) Provisional application No. 63/796,146, filed on Apr. 28, 2025.

(51) Int. Cl. H04L 9/08; H04L 9/32

(52) U.S. Cl. CPC H04L 9/085; H04L 9/0866; H04L 9/0869; H04L 9/3236

(57) ABSTRACT

Systems and methods are described for programming a reconfigurable logic device for use with a programmable symmetric key. The system performs multiple hashes on an input and uses the hashed values to generate a pool of random bits. The pool of random bits may be used to generate a split key using an encryption key or to recreate an encryption key using a split key. The encryption key may be used to decrypt the input.

### INCORPORATION BY REFERENCE TO ANY PRIORITY APPLICATIONS

This application claims priority to U.S. Provisional Application No. 63/767,837, filed on Mar. 6, 2025, and titled “SYSTEM AND METHODS FOR SECURELY LOADING AN ASSOCIATED BITSTREAM INTO RECONFIGURABLE LOGIC USING SELF-AUTHENTICATION,” and also claims priority to U.S. Provisional Application No. 63/796,146, filed Apr. 28, 2025, and titled “SYSTEM AND METHODS FOR SECURELY LOADING AN ASSOCIATED BITSTREAM INTO RECONFIGURABLE LOGIC USING INTEGRITY VERIFICATION AND SELF-AUTHENTICATION,” which are hereby incorporated herein by reference in their entirety.

### TECHNICAL FIELD

The present disclosure generally relates to the use of a symmetric encryption algorithm to reconfigure a bitstream associated with a field-programmable gate array.

### BACKGROUND

Reconfigurable logic devices, such as field-programmable gate arrays (FPGAs) can be loaded with bitstreams that include configurable logic that defines the behavior and functionality of the FPGA.

### BRIEF DESCRIPTION OF DRAWINGS

Throughout the drawings, reference numbers may be re-used to indicate correspondence between referenced elements. The drawings are provided to illustrate example embodiments described herein and are not intended to limit the scope of the disclosure.

FIG. 1 is a block diagram illustrating an example of a system for decrypting an encrypted bitstream programmed into a reconfigurable logic device.

FIG. 2 is a block diagram illustrating the data flow performed by the components of FIG. 1 to enroll an encrypted bit stream into the reconfigurable logic device system.

FIGS. 3A-3C are block diagrams illustrating the data flow performed by the components of FIG. 1 to provision an encrypted bitstream to configure operation of a reconfigurable logic device.

FIG. 3D is a block diagram illustrating the data flow performed by the components of FIG. 1 to decrypt the encrypted bitstream to cause operation of a reconfigurable logic device.

FIG. 4 is a flow diagram depicting a reconfigurable logic device bitstream enrollment system.

FIG. 5 is a flow diagram depicting a reconfigurable logic device bitstream provisioning system.

FIG. 6 is a flow diagram depicting a reconfigurable logic device bitstream decryption system.

### DETAILED DESCRIPTION

In some aspects and/or embodiments, systems, methods, and computer program products described herein relate to a system for enrolling and provisioning a complex programmable logic devices, programmable logic devices, course-grained reconfigurable architectures, and/or reconfigurable logic device (e.g., field-programmable gate arrays, application-specific integrated circuits, etc.) to operate according to an encrypted bitstream. Devices such as reconfigurable logic devices (RLDs) may operate according to instructions provided on a bitstream. A bitstream may be a binary file (e.g., a .bit or .bin file containing a series of bits) that include instructions for operating the RLD, such as the hardware, software, internal routing, input and output devices, etc. When manufactured, the RLD and other similar devices may be enrolled with specific bitstreams to provide an initial function to the RLD. However, one aspect of RLDs and other similar devices are the ability to reprogram the RLDs to operate according to newly introduced bitstreams. For example, an RLD that was initially provisioned to perform first functions according to a first bitstream can be reprovisioned to perform second functions according to a second bitstream. The reprogrammable nature of RLDs allow for a more universal use of RLDs, especially when such RLDs are taken into adversarial territory for use and cannot be easily swapped out for a second device.

Using RLDs and other similar devices in adversarial territory may lead to attackers attempting to infiltrate the RLD and alter its functionality. For example, an attacker may attempt to remotely and/or physically change the application bitstream to modify the RLD's functions. To prevent attack, a user may alternatively provide an encrypted bitstream to the RLD. The RLD may decrypt the encrypted bitstream prior to operation. Some systems may utilize symmetric key encryption algorithms (e.g., a single shared key is used to encrypt and decrypt the bitstream) or asymmetric key encryption algorithms (e.g., a “public” key is used to encrypt the bitstream and a “private” key is used to decrypt the bitstream).

While asymmetric key encryption algorithms may be used to provide authentication and attestation evidence to validate that an application bitstream is from a trusted source, asymmetric based RLD encryptions are increasingly susceptible to attack in a post-quantum computing environment. While symmetric cryptography may be more resilient to attack than asymmetric cryptography, once a shared key is selected for a particular RLD, it is typically fused into the device such that it cannot be changed.

To address these issues, a system is described that uses symmetric cryptography to validate and authenticate a bitstream. The system also enables a user to update a shared key if/when a different application bitstream is to be loaded onto the device. The system may operate in three modes: enrollment, provisioning, and configuration/operation. Although reference herein is made to bitstreams in an RLD, it will be understood that the systems and methods described herein may be used to encrypt, decrypt, validate, and/or authenticate other executable (e.g., software) or configurable logic (e.g., firmware) files for use with an RLD or for other security-related use cases. As such, the description herein related to bitstreams and an RLD is non-limiting, and the methods and systems described herein may be similarly applied to software and/or firmware or encrypting/decrypting other files.

As described herein, as part of the enrollment mode, the system may generate and store a random number generator input key (RNG input key). The RNG input key may be used to generate a split key (as part of the provisioning mode). In some cases, the system may generate the RNG input key using any one or any combination of the output of a random number generator (e.g., physically unclonable function (PUF) and/or digital random number generator), a first encrypted bitstream (e.g., encrypted using a first hash function), and a unique physical signature of the RLD (RLD fingerprint).

As described herein, as part of the provisioning mode, the system may generate and store a version of a split key. The split key may be used to recreate a bitstream encryption key (as part of the configuration or operation mode). In some cases, prior to generating the split key, the system may use the random number generator, the RNG input key, RLD fingerprint, the first encrypted bitstream, and a second encrypted bitstream (e.g., encrypted using a second hash function) to generate a pool of random bits. The system may use the pool of random bits and a bitstream encryption key to generate the version of the split key.

As part of the configuration or operation mode, the system may recreate the bitstream encryption key, use the bitstream encryption key to decrypt the encrypted bitstream, and load the decrypted bitstream into the RLD to configure the RLD for use. In some cases, similar to the provisioning mode, the system may use the random number generator, the RNG input key, RLD fingerprint, the first encrypted bitstream, the second encrypted bitstream, the system may use the random number generator, the RNG input key, RLD fingerprint, the first encrypted bitstream, and the second encrypted bitstream to generate a pool of random bits, and use the pool of random bits and the version of the split key to recreate the bitstream encryption key.

The system described herein provides significant benefits. For example, by using two separate hash engines, the system can significantly increase the difficulty for an attacker to successfully modify the encrypted bitstream. In addition, the system enables the use of a symmetric key without storing the symmetric key on the device. Moreover, the system enables a user to change the configuration of the RLD using a different application bitstream and different symmetric key.

### Example System

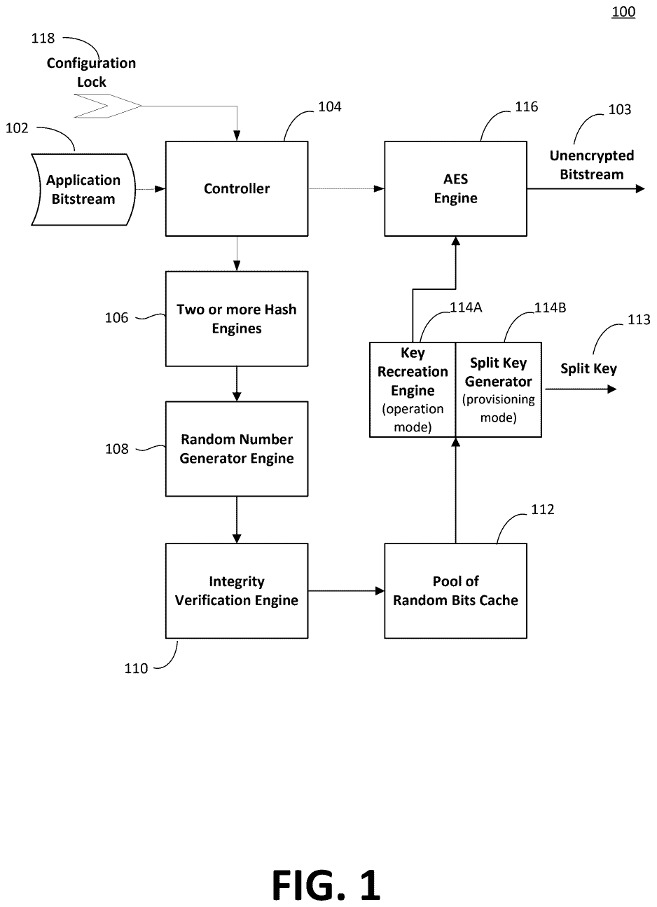

FIG. 1 is an example block diagram of a system 100 for decrypting an application bitstream 102 stored in a reconfigurable logic device (RLD) to generate an unencrypted bitstream 103.
In the illustrated example, the system 100 includes a controller 104, two or more hash engines 106, an RNG engine 108, an integrity verification engine 110, a pool of random bits cache 112, a key engine 114, an AES engine 116, and a configuration lock 118. It will be understood, however, that the system 100 may include fewer or more components. For example, the system 100 may omit the integrity verification engine, key engine 114, etc. The system 100 may receive the application bitstream 102 from a computing device separate from the RLD, such as a mobile computing device connected to the RLD via a wired or wireless connection, or the application bitstream 102 may be stored in non-volatile memory of the RLD. In some cases, the application bitstream 102 may be encrypted using a symmetric encryption algorithm (e.g., advanced encryption standard (AES) algorithm, blowfish, and/or the like) and provided to the controller 104 via a user interface on the computing device.

The bitstream encrypted in the application bitstream 102 may include logic to configure the operation of the RLD. The bitstream may include a series of bits that, when loaded into the RLD during configuration, may affect various operations of the RLD, such as internal logic, data routing, and/or other internal settings.

While FIG. 1 illustrates an application bitstream 102 as the input into the RLD, it will be understood that software and/or firmware may be similarly used as the input. In some cases, the software and/or firmware may be implemented on top of (e.g., after) the application bitstream and/or in place of the application bitstream 102. It will be understood that the processes described herein for encrypting, decrypting, provisioning, and/or validating the application bitstream 102 or bitstream encryption key may be similarly used to encrypt, decrypt, provision, and/or validate software and/or firmware (or associated encryption keys) or other files. In some such cases, a processor or other hardware device configured to execute the software and/or firmware may be held in reset (e.g., a default non-operable state) while the system decrypts and/or installs the associated software and/or firmware (and associated encryption key).

As described herein, the application bitstream 102 may include a series of bits that, when loaded into the RLD during configuration, may affect various operations of the RLD. Firmware may include machine-executable instructions and associated data intended to operate with relatively persistent behavior to closely tied to hardware operation, such as instructions for how a particular hardware device of the RLD is to operate. Software may include higher-level computer-executable instructions and/or typically executed by a host processor or an embedded processor to cause the processor to perform a particular process or algorithm. In some cases, the RLD is first configured using one or more bitstreams. Once configured, firmware and/or software may be installed thereon. In certain cases, certain firmware may be installed on one or more hardware components of the RLD before configuration.

The controller 104 may be implemented using one or more microprocessors, microcontrollers or the like. In some cases, the controller 104 may be implemented by executing general hardware description languages (e.g., Verilog, Very High Speed Integrated Circuit Hardware Description Language (VHDL) code, and/or the like), on a programmable logic device. The controller 104 may be configured to receive the application bitstream 102 and operate according to the current configuration lock 118 state. The configuration lock 118 include two or more states or modes, such as enrollment, provisioning, or configuration/operation.

The enrolling state may indicate that the RLD has not yet stored or been configured to load an application bitstream 102 for operation. As another example, the enrollment state may indicate that the logic and components of the system 100 have not been set up for use with the RLD. As yet another example, the enrollment state may further indicate that the PUF has not been properly characterized for usage (e.g., has not been tested to ensure that the PUF outputs are truly random).

The provisioning state may indicate that the components of the system 100 have been configured for use with the RLD but that the application bitstream 102 has not been configured for use with the RLD (e.g., the split key 113 material has not yet been provisioned into the RLD and/or an old split key 113 is stored thereon that is intended to be, or will be, replaced). As another example, the provisioning state may indicate that the application bitstream 102 has been provided to the RLD, but the RLD is not currently configured to operate according to the application bitstream 102.

If the configuration lock 118 state is set to provisioning mode, the controller 104 may transmit the application bitstream 102 to the two or more hash engines 106, use the RNG engine 108 (and/or integrity verification engine 110) to generate a pool of random bits, and use at least a portion of the pool of random bits from the pool of random bits cache 112 (and a bitstream encryption key) to generate a split key 113 using a key engine 114.

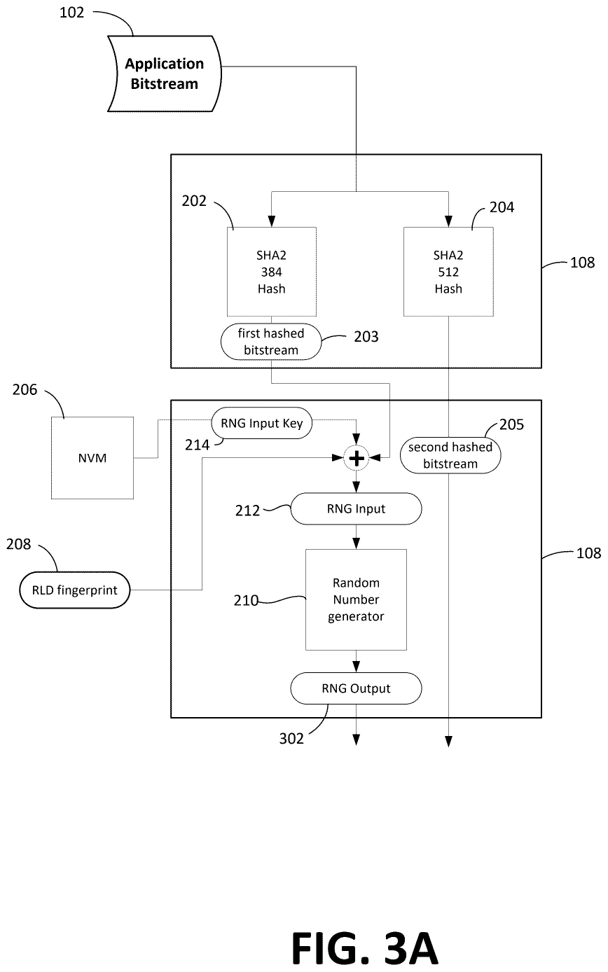

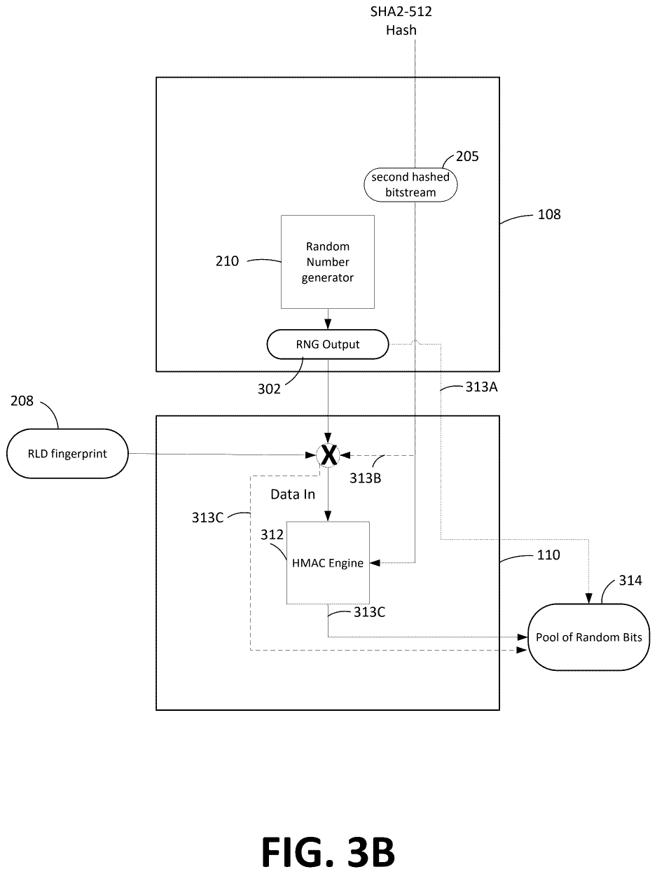

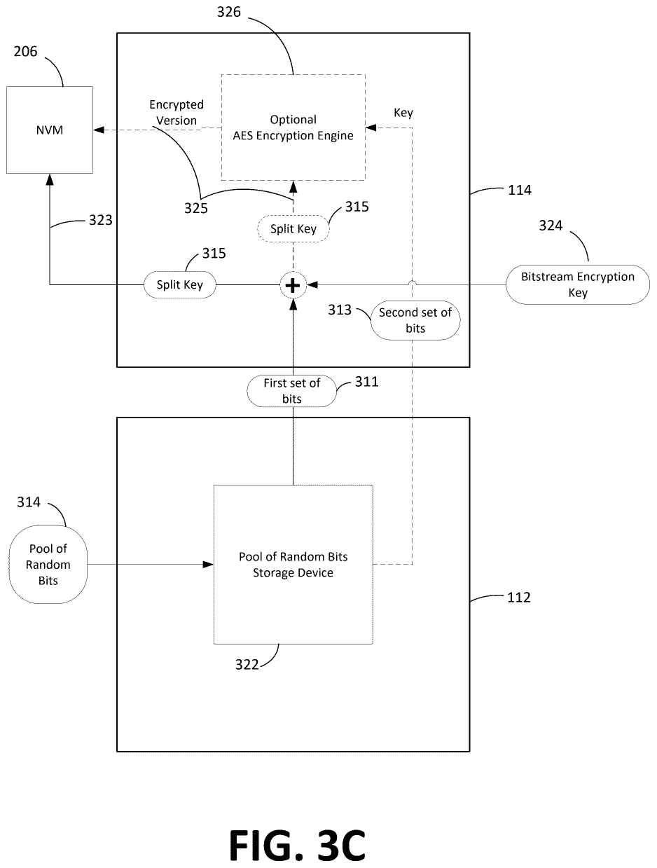

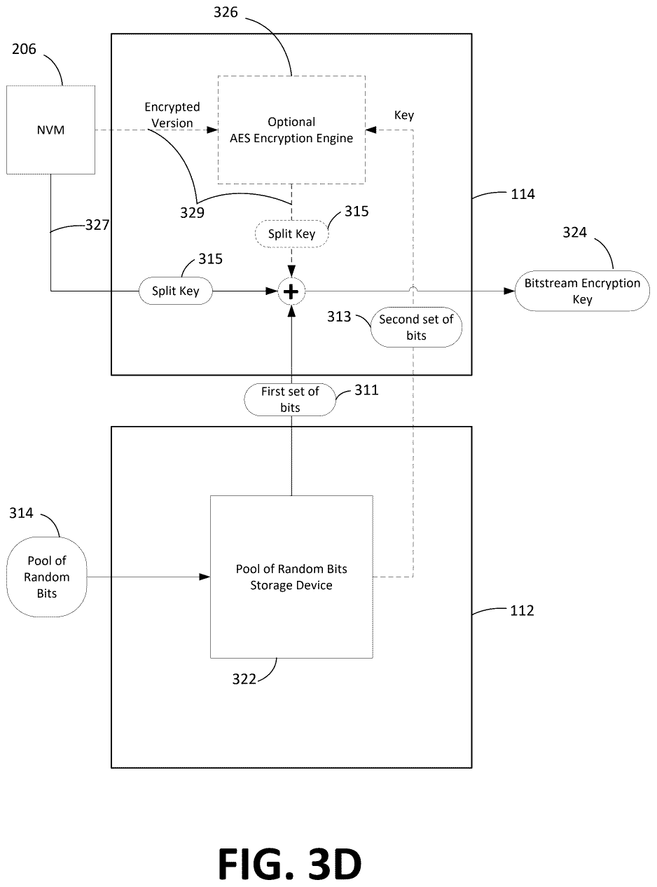

The configuration/operational state may indicate that the RLD is configured to load and operate according to the application bitstream 102 (e.g., and/or the firmware and/or software). If the configuration lock 118 state is set to configuration/operation, the controller 104 may transmit the application bitstream 102 to the two or more hash engines 106, use the RNG engine 108 (and/or integrity verification engine 110) to generate a pool of random bits, and use at least a portion of the pool of random bits from the pool of random bits cache 112 (and the split key generated during the provisioning mode 114B) to recreate the encryption key using the key recreation engine 114A. The recreated encryption key may be used by the AES engine 116 to decrypt the application bitstream 102 (e.g., as described herein with respect to FIGS. 3A, 3B, and 3D) into the unencrypted bitstream 103. As described herein, the unencrypted bitstream 103 may be used to configure and program the RLD. The configuration lock 118 may be a traditional fuse, a circuit breaker, and/or the like. The hash engines 106 may include different secure hash algorithms (SHA), such as SHA2-384, SHA2-512, and/or the like. Alternatively, the two or more hash engines 106 may be implemented using other hashing algorithms that can produce a unique hash from an input (e.g., the application bitstream 102). In some cases, the different hash engines represent different hash functions or different hash algorithms.

As the hash engines are different, each hash engine may generate a different hash from the encrypted bitstream. Thus, a first hash engine may generate a first hashed encrypted bitstream (from the encrypted bitstream) and a second hash engine may generate a second hashed encrypted bitstream (from the same encrypted bitstream) that is different from the first hashed encrypted bitstream. By providing the application bitstream 102 to two or more hash engines 106, the system may reduce the chance of collision attacks. For example, a collision may occur when two unique inputs, when provided to a hashing algorithm, produce the same output. As described herein, as attacks become more sophisticated with the availability of increased computing power and post-quantum computing standards, attackers may become more successful in brute forcing collisions with encrypted bitstreams that are hashed using a single hash engine. However, by utilizing two or more hash engines 106, the attacker would have to brute force a simultaneous collision with both hash engine outputs to enable modification of the application bitstream 102, reducing the likelihood of a successful attack.

The RNG engine 108 may be implemented with one or more random number generators (RNG), such as, but not limited to a physically unclonable function (PUF) and/or digital random number generator that is capable of taking a unique input (e.g., as a seed or challenge) and generating a stream of random bits. The RNG may be configured to generate a stream of random numbers based on a seed or challenge.

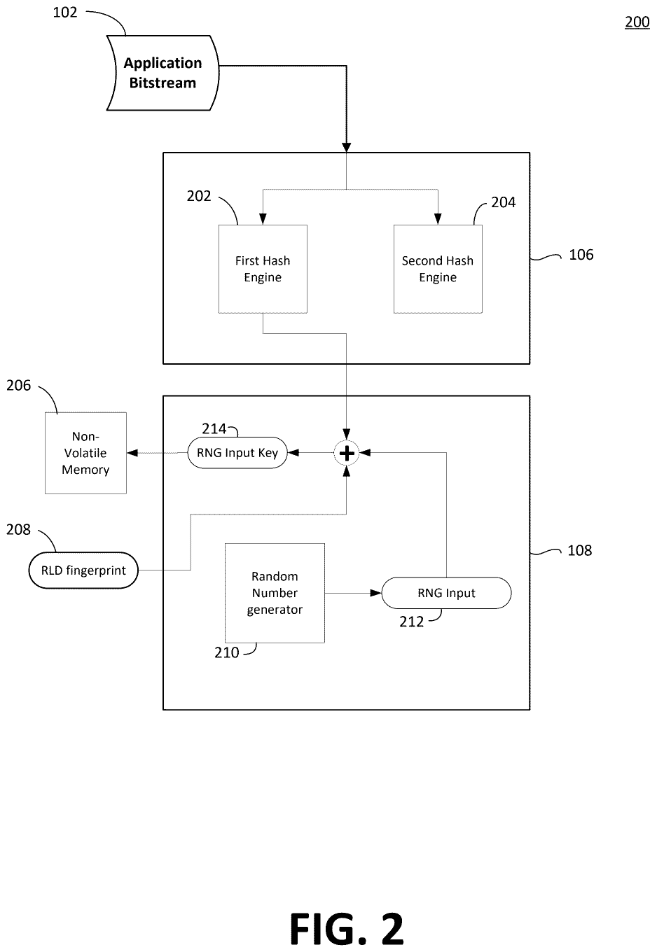

In addition, the RNG engine 108 may include or be communicatively coupled with non-volatile memory to store (or retrieve from storage) an RNG input key and/or an RLD fingerprint. As will be described herein at least with reference to FIG. 2, the RLD input key may be a string of bits used to recreate an RNG input (e.g., seed or challenge) that would result in the recreation of a particular stream of bits output by a random number generator (e.g., an RNG output).

The RLD fingerprint may correspond to a unique physical signature of the RLD. In some cases, the RLD fingerprint may be a subset of bit data from a configuration file that includes information about the RLD. For example, when the RLD is loaded with a bitstream, certain physical components of the RLD will be allocated and used to instantiate the bitstream. Moreover, the physical components will be configured into a unique pattern in accordance with the bitstream. Installing software on top of the configured RLD may further alter the physical components of the RLD. The RLD may track or store information regarding which hardware components of the RLD are being used, their configuration state, etc. This information may be stored in a configuration file or other location of the RLD. Depending on the bitstream that is installed, where it is loaded, the specific physical components that are being used for it (software installed on top of it), and the configuration of those physical components, the configuration file or components themselves will reflect the unique properties of the RLD. These unique properties may be used to generate the unique RLD signature.

In some cases, the actions performed by the RNG engine 108 may vary depending on the state of the configuration lock 118 and/or whether the application bitstream 102 has been enrolled into the RLD. For example, as described herein in further detail with respect to FIG. 2, if the configuration lock 118 is set to enrollment, the RNG engine 108 may use a random number generator to generate an RNG input. The RNG engine 108 may use the RNG input to generate an RNG input key and store the RNG input key in non-volatile memory. In some cases, the RNG engine 108 may use any one or any combination of the RNG input, first hashed encrypted bitstream, or the RLD fingerprint to generate the RNG input key.

As described in greater detail with reference to FIGS. 3A-3B, in the provisioning mode, (e.g., when the configuration lock 118 is in a provisioning state) and/or operating mode (e.g., when the configuration lock 118 is in a configuration/operating state), the RNG engine 108 may access the non-volatile memory to retrieve the RNG input key, and use the RNG input key, recreate the RNG input. In some cases, the RNG engine 108 may use any one or any combination of the RNG input key, first hashed encrypted bitstream, or the RLD fingerprint to generate the RNG input. In certain cases, what is used to recreate the RNG input is based on (or corresponds to) what was used to create the RNG input key. For example, if the RNG input key was created using the RNG input, first hashed encrypted bitstream, and the RLD fingerprint, then the RNG input may be recreated using the RNG input key, first hashed encrypted bitstream, and the RLD fingerprint. The recreated RNG input can be provided to the random number generator to generate an RNG output.

The integrity verification engine 110 may be implemented using an exclusive or function and/or hash-based message authentication code function (HMAC), or the like. In some cases, the integrity verification engine 110 may be configured to receive the output from the RNG engine 108 to generate a pool of random bits.

The integrity verification engine 110 may be implemented using one or more processors, hardware, or device logic. In some cases, the integrity verification engine 110 may be configured to determine or generate a pool of random bits. In certain cases, the integrity verification engine 110 may use the RNG output as the pool of random bits.

In some cases, an attacker with physical access to the RLD may attempt to manipulate the application bitstream 102 and/or gain access to the application bitstream 102. To protect the system 100 from such an attack, the integrity verification engine 110 may use the second hashed encrypted bitstream (from the two or more hash engines 106) with the RNG output to generate the pool of random bits. By associating the RNG output with the second hashed bitstream, any modifications to the second hashed bitstream may result in an alteration of the pool of random bits and an altered encryption key, blocking access to the RLD.

The system may use different methods of associating the RNG output with the second hashed bitstream. For example, in some cases, the integrity verification engine 110 may use the combined RNG output and second hashed bitstream directly as the pool of random bits. In certain cases, the system may use the second hashed encrypted bitstream with a hash-based message authentication code function (HMAC) to modify the RNG output to generate the pool of random bits.

As illustrated in FIG. 1, the pool of random bits may be stored in a pool of random bits cache 112. The pool of random bits cache 112 may be a 2048-bit data cache (or other sized cache) implemented using volatile or non-volatile memory.

The key engine 114 may be implemented using one or more processors, hardware, or the like. In some cases, the actions performed by the key engine 114 may vary depending on the state of the configuration lock 118. For example, if the configuration lock 118 is set to provision, the key engine 114 may generate and store a split key using a bitstream encryption key, whereas if the configuration lock 118 is set to configuration or operation, the key engine 114 may recreate the bitstream encryption key using the stored split key.

As described herein, at least with reference to FIG. 3C, if the configuration lock 118 is set to provision, the key engine 114 may use a subset of the pool of random bits and the bitstream encryption key to generate a split key and store a version of a split key in non-volatile memory. For example, the key engine 114 may access the random bits cache 112 to retrieve a subset of the pool of random bits to combine with the bitstream encryption key. In some cases, the key engine 114 retrieves a subset of the pool of random bits of the same size (e.g., number of bits) as the bitstream encryption key. In certain cases, the subset of the pool of random bits is combined (e.g., via an exclusive or) with the encryption key to generate a split key. Accordingly, the split key may be related to (e.g., based on, generated from, etc.) the encryption key but is not the encryption key itself. In this way, the system can store the split key that can enable it to later recreate the encryption key while disallowing an attacker to access the system and retrieve a stored version of the encryption key. The split key may be stored in non-volatile memory to be later accessed by the system during a configuration or operation mode.

In some cases, the split key may be further provided as input to a keyed AES encryption algorithm to encrypt the split key. In such cases, the key engine 114 may retrieve a second subset of the pool of random bits from the random bits cache 112 to use as the key for the AES encryption algorithm. In some such cases, the output of the AES encryption algorithm may be stored in the non-volatile memory instead of the split key. Although described as using AES encryption, it will be understood that other encryption algorithms may be used.

As another non-limiting example, as described at least with reference to FIG. 3D, if the configuration lock 118 is set to configuration or operation, the key engine 114 may use a subset of the pool of random bits (same subset as was used during provisioning) and the split key to recreate the bitstream encryption key. Once recreated, the encryption key can be provided to the AES engine 116 to decrypt the application bitstream 102. For example, the controller 104 may provide the application bitstream 102 (e.g., and/or the binary representation of the firmware and/or software associated with a RISC-V processor) to the AES engine 116 as the input, recreate the bitstream encryption key as the key for the AES engine 116 as described herein, and provide the recreated bitstream encryption key to the AES engine 116. The AES engine 116 may output the unencrypted bitstream 103 that can be used to configure the RLD to operate.

FIG. 2 is a data flow diagram illustrating an example of the flow of data that may occur during enrollment of an RLD. As described herein, while FIG. 2 illustrates an encrypted bitstream as the input into the RLD, it will be understood that software and/or firmware files may be similarly used as the input, and the processes and steps described herein with reference to a bitstream may be similarly performed on software and/or firmware files (e.g., executable files, binary file or binary representation of the software and/or firmware files.).

As described herein, the system may enter an enrollment mode or state in response to the output from the configuration lock 118. As an illustrative example, when an RLD is initially manufactured (e.g. and has not previously been provisioned), the configuration lock 118 may be set to the enrollment state. In such cases, the controller 104 may transmit the application bitstream 102 to the two or more hash engines 106 to enroll the RLD.

As described herein, the two or more hash engines 106 may include a first hash engine 202 and a second hash engine 204. The first hash engine 202 may be a SHA2-384 hashing algorithm or any other similar hashing algorithm. The second hash engine 204 may be a SHA2-512 hashing algorithm or any other similar hashing algorithm. The first hash engine 202 and the second hash engine 204 may be distinct hashing algorithms so that, when provided with the application bitstream 102, they produce different values. As described within, by using two distinct hashing algorithms for the first hash engine 202 and the second hash engine 204, the system can reduce the likelihood of an attacker brute forcing a collision to replace the application bitstream 102 and gain access to the RLD. In the example FIG. 2, the block diagram 200 illustrates only the first hash engine 202 hashing the application bitstream 102, however, it will be understood that either hash engine 202, 204 may be used. Moreover, as described herein at least with reference to FIGS. 3A-3B, when the configuration lock 118 is in the provisioning and/or the run-time state, the second hash engine 204 can simultaneously hash the application bitstream 102 to produce a second hashed application bitstream. As illustrated in FIG. 2, the RNG engine 108 may further include or be associated with non-volatile memory 206, an RLD fingerprint 208, and a random number generator 210 configured to generate an RNG input 212.

As described herein, the random number generator 210 may be a digital random number generator, a physically uncloneable function (PUF), and/or the like. A PUF is a physical object whose operation cannot be reproduced by another similar physical object. PUFs may rely upon a collection of analog circuits or electrical pathways (e.g., traces) from which measurements of some manufacturing characteristic can be converted to digital values that are unique for every part. Not all circuits or pathways prove to be amenable to either generating the desired uniqueness or being able to do so consistently across various ranges of temperature and voltage. To address this issue, the RNG input 212 can include the portions of the stream of random bits that satisfy the thresholds or other requirements related to uniqueness and stability (e.g., from certain portions of the RNG found to produce reliable and/or random values). Moreover, the RNG input 212 may exclude streams of random bits produced by the random number generator 210 that are not adequately unique or do not satisfy the threshold or other requirements related to uniqueness and stability (e.g., from portions of the RNG found not to produce reliable and/or random values).

In some cases, such as when using a PUF, a collection of data referred to as “helper” data may be stored in non-volatile memory. The helper data may be used to feed information to the PUF circuit to determine what information from the PUF may be used or not used. For instance, if a PUF has 4,000 traces (e.g., physical pathways, or electrical signal routes/pathways), during the enrollment phase, it may be determined that only 2,500 of the traces are capable of producing reliable and random values. The helper data may be used to identify the 1,500 traces that are invalid and/or not to be used. Data from the 2,500 “good” traces may be used to generate the random number from the PUF.

The RNG input 212 can be combined with (e.g., perform an exclusive or on) the first hashed bitstream and the RLD fingerprint 208 to generate the RNG input key 214.

The controller 104 may retrieve the RLD fingerprint 208 from different locations based on the specific RLD. For example, the controller 104 may retrieve the RLD fingerprint 208 for an RLD produced by Altera from the Altera SDM interface. The resulting RNG input key 214 produced by combining the RNG input key from the random number generator 210, the first hashed bitstream, and the RLD fingerprint 208 may be stored in the non-volatile memory 206. Once the RNG input is stored in non-volatile memory 206, the RLD may enter (e.g., via the configuration lock 118) the provisioning state to provision the RLD to operate according to the application bitstream 102. Accordingly, when the configuration lock 118 is set to the provisioning state, the RNG input key 214 may already be stored in the non-volatile memory 206 and accessible by the RNG engine 108.

FIGS. 3A-3B are data flow diagrams illustrating example steps by the system 100 in a provisioning state to provision an RLD for use with an encrypted bitstream and to decrypt the encrypted bitstream in a configuration/operation state. As described herein, while FIGS. 3A-3B illustrate an encrypted bitstream as the input into the RLD, it will be understood that software and/or firmware files may be similarly used as the input, and the processes and steps described herein with reference to a bitstream may be similarly performed on software and/or firmware files (e.g., executable files, binary file or binary representation of the software and/or firmware files.).

Accordingly, it will be understood that, when the configuration lock 118 is set to the operation/configuration state and/or the provisioning state, the operations described herein with reference to FIGS. 3A and 3B may be the same or similar. For example, whether the configuration lock 118 is in the provisioning or the configuration state, the components illustrated in FIGS. 3A and 3B may perform similar function to generate the same RNG output 302.

In the illustrated example FIG. 3A, the application bitstream 102, the two or more hash engines 106, and the RNG engine 108 are shown. Similar to FIG. 2, in the illustrated example of FIG. 3A, the two or more hash engines 106 include the first hash engine 202 and the second hash engine 204. Moreover, the RNG engine 108 includes or is associated with the non-volatile memory 206, the RLD fingerprint 208, and the random number generator 210. FIG. 3A further illustrates the RNG input key 214, RNG input 212, and the RNG output 302. As described herein, the RNG output 302 can be provided to the integrity verification engine 110 (as will be described herein with respect to FIG. 3B).

As illustrated in FIG. 3A, in response to the configuration lock 118 being in the provisioning state, the controller 104 may instruct the system to operate according to the provisioning instructions. In some such cases, the application bitstream 102 may be hashed by both the first hash engine 202 and the second hash engine 204 (similar to what is described with reference to FIG. 2) to generate a first hashed (encrypted) bitstream 203 and a second hashed (encrypted) bitstream 205.

In some cases, the first hashed bitstream, the RNG input key 214, and the RLD fingerprint 208 are used (e.g., combined) to reproduce the RNG input 212. In the illustrated example, the first hashed bitstream, the RNG input key 214, and the RLD fingerprint 208 are exclusively or to recreate the RNG input 212, however, it will be understood that a variety of techniques may be used to generate the RNG input 212 using any one or any combination of the first hashed bitstream, the RNG input key 214, and the RLD fingerprint 208.

The recreated RNG input 212 may be provided to the random number generator 210. As described herein, the random number generator 210 may generate the RNG output 302 based on (e.g., using) the RNG input 212. As described herein, in some cases, the RNG input 212 is used as a seed for a digital random number generator and/or as a challenge for a PUF.

As described herein, the integrity verification engine 110 may generate a pool of random bits 314 based on (e.g., using) the RNG output 302. In some cases, the integrity verification engine 110 may verify the integrity of the RNG output 302 to further protect the RLD from an attacker with physical access.

As illustrated in the example FIG. 3B, the random number generator 210 of the RNG engine 108 generate an RNG output 302. As described herein, the RNG output may be a stream of random bits generated in response to the RNG input 212 and the physical or other characteristics of the random number generator 210.

In the illustrated example, the integrity verification engine 110 generates a pool of random bits 314 based on (e.g., using) any combination of the RLD fingerprint 208 and the RNG output 302. In some cases, the RNG output 302 may be used directly (e.g., as is or without change) as the pool of random bits 314 as shown in path 313A.

In certain cases, the RNG output 302 may be combined with the RLD fingerprint 208 and/or the second hashed bitstream to create the pool of random bits 314 to provide to the random bits cache 112. For example, the integrity verification engine 110 may apply one or more functions to the RNG output 302, RLD fingerprint 208, and the second hashed bitstream, such as an exclusive or, to generate the pool of random bits 314. In certain cases, the resulting combination may be used as is (e.g., without further changes) the pool of random bits as illustrated in path 313B.

In some cases, to provide further authenticity and integrity to the pool of random bits 314, the integrity verification engine 110 may use an HMAC to generate the pool of random bits, as shown by path 313C. In some such cases, the RNG output 302 may be combined with the RLD fingerprint 208 (using on or more functions such as an exclusive or) and provided to the HMAC engine 312.

The HMAC engine 312 may use a hash-based message authentication code (HMAC) function to verify the integrity and authenticity of the input (e.g., the RNG output 302). The HMAC engine 312 may use a shared key to verify and authenticate the RNG output 302. In some such cases, the HMAC engine 312 may use the second hashed bitstream as the key to authenticate the RNG output 302 is from the authorized user (and was not modified and/or altered by an attacker).

The pool of random bits 314 (e.g., the RNG output 302, the RNG output 302 combined with the RLD fingerprint 208 and the second hashed bitstream, or the output from the HMAC engine 312) may be stored in the random bits cache 112. During a provisioning state, the pool of random bits may be used (with a bitstream encryption key) to create and store a split key associated with the application bitstream 102. During a configuration/operation state, the pool of random bits may be used (with the split key) to recreate the bitstream encryption key. The recreated bitstream encryption key may be used to decrypt the application bitstream 102 and configure the RLD.

FIG. 3C is a data flow diagram illustrating an example data flow for creating and storing the split key (e.g., when the system 100 is in a provisioning mode). In the illustrated example, a pool of random bits storage device 322 is illustrated as well as the key engine 114. As described herein, while FIG. 3D illustrates creating and storing a split key associated with a bitstream encryption key, it will be understood that split keys may be created using encryption keys for software and/or firmware, and the processes and steps described herein with reference to a bitstream or bitstream encryption key may be similarly performed using software and/or firmware files (e.g., executable files, binary file or binary representation of the software and/or firmware files.) or encryption keys associated with software and/or firmware files.

As described herein, the pool of random bits storage device 322 may be implemented using a 2048-bit data cache of volatile (or non-volatile memory). Accordingly, the pool of random bits storage device 322 may temporarily store the pool of random bits 314 during the provisioning and/or configuration phases. At the end of each phase, the pool of random bits storage device 322 may be reset and/or discard the pool of random bits 314. As such, the pool of random bits storage device 322 may not permanently store the pool of random bits 314.

The key engine 114 may receive/retrieve a first set of bits 311 from the pool of random bits stored in the pool of random bits storage device 322. The key engine 114 may generate the split key 315 based on (e.g., using) the first set of bits 311 and/or the bitstream encryption key 324. In some cases, the key engine 114 generates the split key 315 by performing an exclusive or on the first set of bits 311 and the bitstream encryption key 324. Accordingly, in some cases, the length (or number) of the first set of bits 311 may be the same length (or same number) as bits that make up the bitstream encryption key 324. In certain cases, they may be different (e.g., longer/more or shorter/less).

A version of the split key 315 may be stored in non-volatile memory 206, which may be the same or different non-volatile memory that is used to store the RNG input key 214 and the RLD fingerprint 208. In some cases, the version of the split key 315 that is stored is the same as the split key 315 generated from the set of bits and the bitstream encryption key 324, as shown in path 323.

In certain cases, the version that is stored is an encrypted version or other version, as shown in path 325. For example, the split key 315 may be input into an AES encryption engine 326 (or other encryption engine). In some such cases, a second set of bits 313from the pool of random bits storage device 322 may be used as a key for the AES encryption engine 326. The encrypted version of the split key, output from the AES encryption engine 326, may be stored in the non-volatile memory 206. Utilizing the AES encryption engine 326 may provide another layer of encryption to the system to further enhance the security of the bitstream by reducing the likelihood that an attacker can modify the bitstream to alter the operation of the RLD.

Once the split key is generated and stored in the RLD fingerprint 208, the configuration lock 118 may update the state to configuration or operational. As described herein, in the configuration/operational state, the system may decrypt the application bitstream 102 and use it to configure the RLD for operation.

In some cases, the provisioning state may occur within a secure facility, such as at the time of manufacture. In certain cases, the configuration or operational state may be the state in which the RLD is in for the majority of the time. For example, it may represent the state of the RLD when it is outside of the manufacturing facility, operating in the field or deployed. In some cases, once provisioning is complete, the RLD may operate in the configuration or operational mode until such time that it is to have another bitstream loaded onto it. In some such cases, the RLD may be placed in the provisioning state. Using the techniques described herein, the RLD is configured to be placed into a secure provisioning state and have its bitstream updated in a secure manner.

FIG. 3D is a data flow diagram illustrating an example data flow for recreating the bitstream encryption key 324 (e.g., when the system 100 is operating in a configuration/operational state). As described herein, while FIG. 3D illustrates recreating a bitstream encryption key, it will be understood that encryption keys for software and/or firmware may be similarly recreated, and the processes and steps described herein with reference to a bitstream or bitstream encryption key may be similarly performed to recreate encryption keys associated with software and/or firmware files (e.g., executable files, binary file or binary representation of the software and/or firmware files.).

As described herein, in the configuration/operational state, the system 100 may perform the process steps described herein with reference to FIGS. 3A and 3B to generate the pool of random bits. Similarly, the system 100 may store the pool of random bits 314 in the pool of random bits storage device 322, as described herein with reference to FIG. 3C.

However, to recreate the bitstream encryption key 324, certain steps may be different (or reversed) relative to FIG. 3C. For example, as illustrated in FIG. 3D, the split key 315 may be combined with the first set of bits 311 (e.g., the same first set of bits that were used to create the split key 315) to recreate the bitstream encryption key 324.

In some cases, the split key 315 may be retrieved from the non-volatile memory and used as-is with the first set of bits 311, as shown in path 327. In certain cases, such as when using the optional AES encryption engine 326, the split key 315 may be reconstituted or decrypted by retrieving an encrypted version of the split key 315 from the non-volatile memory and decrypting it using the AES encryption engine 326 and the second set of bits 313 (e.g., the same second set of bits that were used to encrypt the split key 315), as illustrated in path 329. As described herein with reference to FIG. 3C, the second set of bits 313 may be used as the key for the AES encryption engine 326 to decrypt the split key 315.

The split key 315 (determined via path 327 or path 329) may be used with the first set of bits to recreate the bitstream encryption key 324. In some cases, the split key 315 may be combined with the first set of bits 311, such as by performing an exclusive or, to generate the bitstream encryption key 324.

As described herein at least with reference to FIG. 1, the bitstream encryption key 324 may be provided to the AES engine 116 to decrypt the (encrypted) application bitstream 102. For example, during the configuration/operational state, in addition to providing the application bitstream 102 to the two or more hash engines 106, the controller 104 may additionally provide the application bitstream 102 to the AES engine 116 as the input. In response to receiving the application bitstream 102 input and the bitstream encryption key 324 shared key, the AES engine 116 may decrypt the application bitstream 102 into the unencrypted bitstream 103 to configure operation of the RLD.

As described herein, software and/or firmware such as a RISC-V processor may configure operation of the RLD in place of the application bitstream 102. In such cases, the RISC-V may be held in reset (e.g., a default non-operable state) while the AES engine 116 decrypts the associated software and/or firmware. Once decrypted, the RLD may operate according to the RISC-V processor the same as or similar to the application bitstream 102.

It will be understood that the RLD may be provisioned and operate with multiple bitstreams. For example, the process as described herein with respect to provisioning and configuring/operating the RLD and may be repeated for a second encrypted bitstream that is configured to also be loaded onto the RLD. In some such cases, the different encrypted bitstreams may use different symmetric keys for encryption and decryption. Accordingly, in some such cases, during the provisioning and operational states, the system 100 may recreate the different symmetric keys based on the bitstream associated with the corresponding key.

Moreover, the different provisioning processes for the different bitstreams may rely on or use the same or different RLD fingerprints. For example, the RLD fingerprint for all bitstreams may correspond to the unique physical characteristics of the RLD before any application bitstreams are loaded thereon (e.g., only the bitstream corresponding to the system 100 is loaded). In some such cases, the different encrypted bitstreams may use the same RLD fingerprint when generating the RNG input key, recreating the RNG input, and generating the pool of random bits.

In certain cases, the RLD fingerprints may be different for different bitstreams. For example, the RLD fingerprint for the first bitstream may correspond to the unique physical characteristics of the RLD before any application bitstreams are loaded thereon (e.g., only the bitstream corresponding to the system 100 is loaded). The RLD fingerprint for the second bitstream may correspond to the unique physical characteristics of the RLD after one or more application bitstreams are loaded thereon (e.g., in addition to the bitstream corresponding to the system 100). As such, the RLD fingerprints for the different bitstreams may be different.

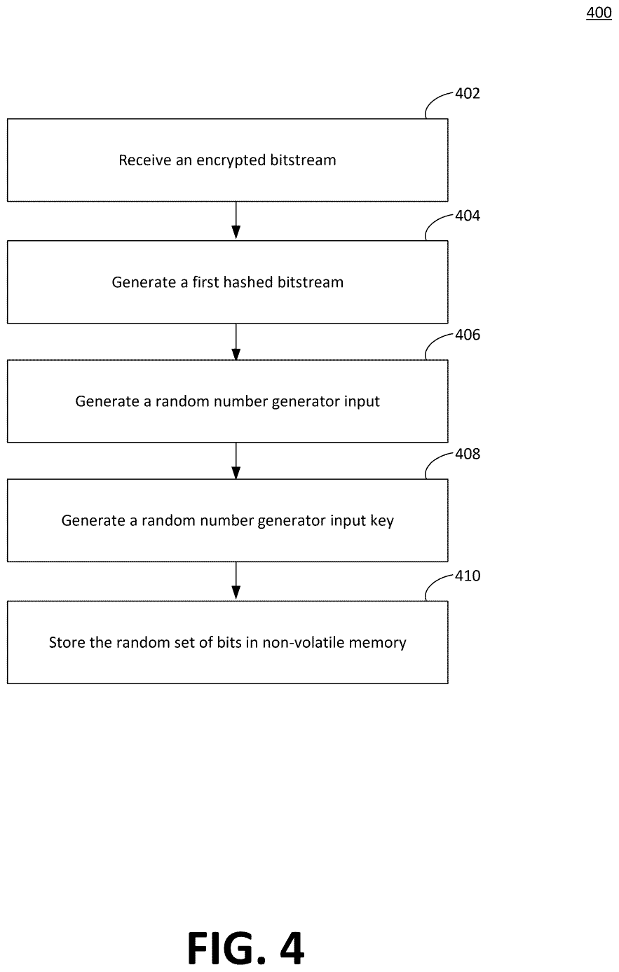

FIG. 4 is a flow diagram illustrating an example of a process 400 for enrolling an RLD for use with a programmable symmetric key. As described herein, while FIG. 4 describes enrolling an RLD for use with a programmable symmetric key associated with a bitstream, it will be understood that similar steps and methods may be used for a programmable symmetric key associated with software and/or firmware files. As such, references to a bitstream, encrypted bitstream, and encrypted bitstream key are illustrative in nature, and the steps and processes described herein may be used with software/firmware files, encrypted software/firmware files, and encryption keys associated with software/firmware files.

The process 400 may be executed, for example, by using one or more processors or computing devices associated with the RLD, such as a processor or computing device associated with the system 100. For simplicity, the process 400 will be described as being performed by a system.

At block 402, the system receives an encrypted bitstream. In some cases, the encrypted bitstream may be a binary file (e.g., a series of bits) that includes operational instructions for an RLD, such as an FPGA. The encrypted bitstream may be provisioned (e.g., loaded, transferred, etc.) into the RLD's circuitry to define the RLD hardware's logical functions, internal connections, input/output settings, and/or the like.

At block 404, the system generates a first hashed bitstream. The system may provide the encrypted bitstream to a first hash function (e.g., first hash engine 202) to output a hashed value associated with the encrypted bitstream. In some cases, the first hash function may be a SHA2-384, SHA2-512, and/or other hashing function.

At block 406, the system generates a random number generator input (RNG input) for a random number generator. The system may generate the RNG input by using a random number generator, such as a digital random number generation, a physically uncloneable function (PUF), and/or the like. The random number generator may iteratively validate the random bits to confirm they are unique and can be generated consistently or in a stable way. For example, due to external factors such as temperature, incoming voltage, and/or the like, the output from the random number generator may not be unique or stable. In such cases, the random number generator can validate the outputs and/or discard invalid outputs.

At block 408, the system generates the RNG input key. In some cases, the system generates the RNG input key using (e.g., by combining) the generated first hashed bitstream, the RNG input, and an RLD fingerprint. In certain cases, the ** may be combined using an exclusive or function. As described herein, the RLD fingerprint may be a subset of bit data that includes information about the RLD. The RLD fingerprint may be unique to the particular RLD and may be generated using the bitstreams, hardware, firmware, software, configurations, and/or other aspects of the RLD.

At block 410, the system may store the RNG input key in non-volatile memory for provisioning and/or configuration/operation. As described herein, the RNG input may be stored in the non-volatile memory until the system provisions and/or initiates operation of the RLD according to the encrypted bitstream.

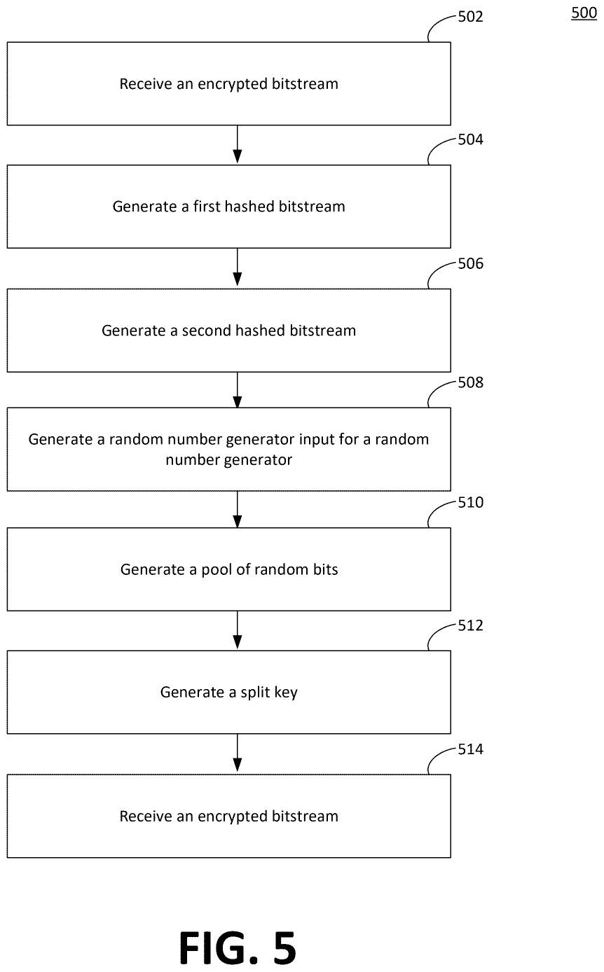

FIG. 5 is a flow diagram illustrating an example of a process 500 for provisioning an RLD with a programmable symmetric key. As described herein, while FIG. 5 describes provisioning an RLD with a programmable symmetric key associated with a bitstream, it will be understood that similar steps and methods may be used for a programmable symmetric key associated with software and/or firmware files. As such, references to a bitstream, encrypted bitstream, and encrypted bitstream key are illustrative in nature, and the steps and processes described herein may be used with software/firmware files, encrypted software/firmware files, and encryption keys associated with software/firmware files.

The process 500 may be executed, for example, by using one or more processors or computing devices associated with the RLD, such as a processor or computing device associated with the system 100. For simplicity, the process 500 will be described as being performed by a system. In some cases, the system performs process 500 when it is operating in a provisioning state or provisioning mode.

At block 502, the system receives an encrypted bitstream that is associated with an RLD. In some cases, block 502 may be the same as or similar to block 402 of FIG. 4. For example, the encrypted bitstream received by the system may be the same binary file encrypted bitstream that the system received to enroll the RLD.

At block 504, the system generates a first hashed bitstream. The system may generate the first hashed bitstream using the encrypted bitstream as input to a first hash function. In some cases, the first hashed bitstream may be the same as the first hashed bitstream described at block 404 of FIG. 4. For example, when provided with the same encrypted bitstream, the first hash function may output the same first hashed bitstream as during enrollment.

At block 506, the system generates a second hashed bitstream. The system may generate the second hashed bitstream using the encrypted bitstream as input to a second hash function. The second hash function may be a different hash function than the first hash function. For example, if the first hash function is a SHA2-384 hashing algorithm, the second hash function may be a SHA2-512 hashing algorithm (or vice versa). By using a different hashing algorithm for the second hash function than the first hash function, the system reduces the likelihood that an attacker could brute force a collision to infiltrate the system. For example, two distinct hashing algorithms would force an attacker to simultaneously brute force two collisions (e.g., a first collision with the first hashing function and a second collision with the second hashing function), the likelihood that an attacker could cause simultaneous collisions is lower than the likelihood that the attacker could cause a collision with only one hashing algorithm, further securing the system.

At block 508, the system generates a random number generator input (RNG input) for a random number generator. In some cases, the RNG input may be the first hashed bitstream (e.g., the RNG input is the first hashed bitstream). To further increase the security level of the system, in some cases, the system may generate the RNG input using (e.g., by combining) the first hashed bitstream with an RLD fingerprint. In certain cases, the system combines the first hashed bitstream with an RLD fingerprint using an exclusive or function.

As described herein, the RLD fingerprint may be generated and stored on the RLD. The RLD fingerprint may be a subset of bit data that includes information (e.g., measurements) about the RLD. The RLD fingerprint may be unique to the particular RLD that identifies the RLD by its bitstreams, hardware, firmware, software, and/or other aspects of the RLD.

In certain cases, the system may generate the RNG input by combining (e.g., performing an exclusive or on) the first hashed bitstream, the RLD fingerprint, and an RNG input key. As described herein, the RNG input key may be generated from a subset of random bits generated by a random number generator, such as a PUF. As another example, the system may generate the RNG input by combining the first hashed bitstream and the RNG input key.

At block 510, the system generates a pool of random bits. The pool of random bits may be generated based at least in part on the second hashed bitstream and/or an RNG output from the random number generator. In some cases, the system may provide the random number generator with the RNG input to generate the RNG output. As described herein, the RNG input may be generated using the first hashed bitstream and the RNG input key. For example, if RNG input key was generated by combining the first hashed bitstream and the RNG input, the RNG input may be recreated by combining the first hashed bitstream with the RNG input key.

In some cases, the pool of random bits may be the same as the RNG output. For example, the system may use some portion of the RNG output as the pool of random bits.

In certain cases, to the system may generate the pool of random bits by combining (e.g., performing an exclusive or on) any combination of the second hashed bitstream, the RNG output, and the RLD fingerprint.

In some cases, the system may generate the pool of random bits using a hash-based authentication code (HMAC). In certain cases, the system may generate an HMAC input by combining (e.g., preforming an exclusive or on) the RNG output and the RLD fingerprint. The system can then generate an HMAC output using HMAC input and the second hashed bitstream as a key to the HMAC. In such cases, the system may use the HMAC output (or some portion thereof) as the pool of random bits.

At block 512, the system generates a split key. The split key may be related to the symmetric key (e.g., the bitstream encryption key) but is not the symmetric key itself. For example, the split key may be configured to be used by the system to recreate the bitstream encryption key.

In some cases, the system may generate the split key by performing an exclusive or on a first set (or subset) of bits from the pool of random bits and a bitstream encryption key. As described herein, the bitstream encryption key may be the symmetric key that can be used to decrypt the encrypted bitstream. In some cases, the first set (or subset) of bits from the pool of random bits, the bitstream encryption key, and the split key may have the same length (e.g., the same number of bits).

At block 514, the system may store the split key in non-volatile memory. In some cases, the split key may be later accessed by the system during a configuration or operational state. In certain cases, the system may store the split key itself (e.g., the version of the split key that was generated at block 512).

In certain cases, the system stores a different version of the split key, such as an encrypted version. For example, the system may use the split key as input to an encryption function, encrypting the split key using a second set (or subset) of bits from the pool of random bits as a key, and store the encrypted split key in the non-volatile memory.

By generating and storing the split key rather than the bitstream encryption key itself, the system can store the components to recreate the bitstream encryption key, thereby making it difficult if not impossible for an attacker to retrieve the bitstream encryption key from the RLD. Moreover, by dynamically generating and storing a split key based on the encrypted bitstream and characteristics of the RLD (e.g., RLD fingerprint) rather than hardcoding a symmetric encryption key, the system enables the use of programmable symmetric encryption keys. In particular, the system enables a user to configure and use an RLD using an encrypted bitstream associated with a first (symmetric) bitstream encryption key, and, at a later date, re-provision the RLD for use with a second bitstream associated with a second bitstream encryption key.

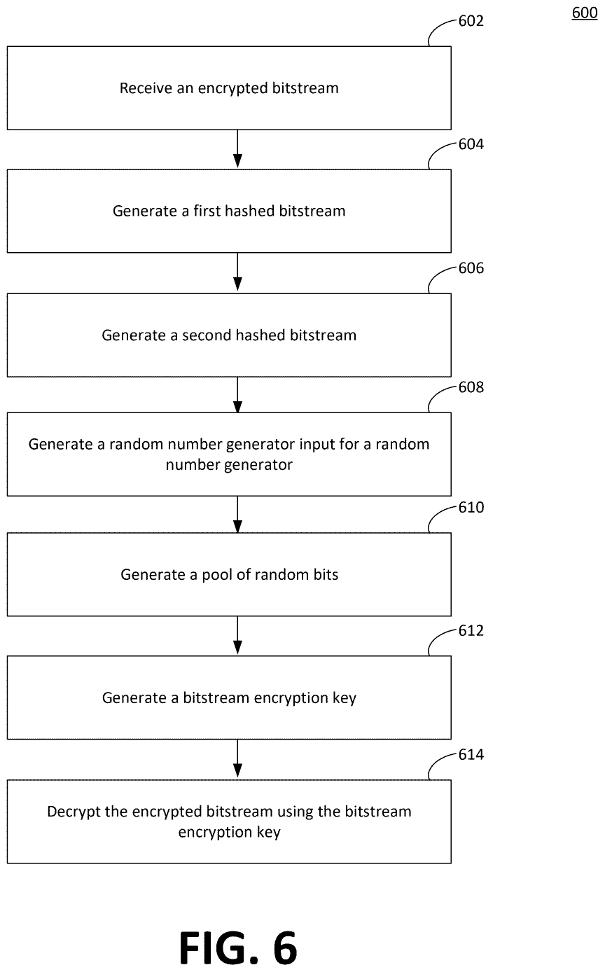

FIG. 6 is a flow diagram of an example process 600 for authenticating an encrypted bitstream using a programmable symmetric key for operating an RLD. As described herein, while FIG. 6 describes authenticating an encrypted bitstream, it will be understood that similar steps and methods may be used to authenticate a firmware and/or software. As such, references to a bitstream, encrypted bitstream, and encrypted bitstream key are illustrative in nature, and the steps and processes described herein may be used with software/firmware files, encrypted software/firmware files, and encryption keys associated with software/firmware files.

The process 600 may be executed, for example, by using one or more processors or computing devices associated with the RLD, such as a processor or computing device associated with the system 100. For simplicity, the process 600 will be described as being performed by a system. In some cases, the system performs process 600 when it is operating in a configuration mode/state or operational mode/state.

At block 602, the system receives an encrypted bitstream. The encrypted bitstream of block 602 may be the same as or similar to block 402 and block 502.

At block 604, the system generates the first hashed bitstream and at block 606, the system generates the second hashed bitstream. The system may generate first hashed bitstream and second hashed bitstream similar to the manner described herein with respect to block 504 and block 506, respectively, of FIG. 5.

At block 608, the system generates an RNG input for a random number generator, similar to block 508 of FIG. 5. As described herein with respect to block 508, the system may generate the RNG input by performing an exclusive or on the first hashed bitstream, the RLD fingerprint and/or the RNG input key.

At block 610, the system generates a pool of random bits, similar to block 510 of FIG. 5. As described herein with respect to block 510, the pool of random bits may be the RNG output. Alternatively, the pool of random bits may be generated by combining (e.g., performing an exclusive or on) some combination of the RNG output, the RLD fingerprint, and the second hashed bitstream. In some cases, the pool of random bits may be the output of an HMAC function.

At block 612, the system generates a bitstream encryption key. In some cases, the system may generate the bitstream encryption key by combining (e.g., performing an exclusive or on) a first set (or subset) of bits from the pool of random bits and a split key. In some cases, if the split key was initially generated by combining the first set (or subset) of bits from the pool of random bits and the bitstream encryption key, then the bitstream encryption key can be recreated by combining the split key and the first subset of bits from the pool of random bits. In some such cases, the first set of bits from the pool of random bits and the split key may have the same length (e.g., the same number of bits).

Additionally or alternatively, if the split key was initially encrypted before the system stored the split key in non-volatile memory, the system may generate the bitstream encryption key by decrypting the split key using a second set (or subset) of bits from the pool of random bits as a key to an AES encryption function and generating the bitstream encryption key by performing an exclusive or on the first subset of bits and the decrypted split key.

At block 614, the system decrypts the encrypted bitstream using the bitstream encryption key. The system may provide the encrypted bitstream as input to an AES encryption function to decrypt using the bitstream encryption key as the key. In such cases, the decrypted encrypted bitstream may be loaded onto the RLD to configure the RLD to operate according to the instructions included in the decrypted bitstream.

### Terminology

In the foregoing description, aspects and embodiments of the present disclosure have been described with reference to numerous specific details that can vary from implementation to implementation. Accordingly, the description and drawings are to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction. Any definitions expressly set forth herein for terms contained in such claims shall govern the meaning of such terms as used in the claims. In addition, when we use the term “further comprising,” in the foregoing description or following claims, what follows this phrase can be an additional step or entity, or a sub-step/sub-entity of a previously recited step or entity.

Any or all of the features and functions described herein can be combined with each other, except to the extent it may be otherwise stated above or to the extent that any such embodiments may be incompatible by virtue of their function or structure, as will be apparent to persons of ordinary skill in the art. Unless contrary to physical possibility, it is envisioned that (i) the methods/steps described herein may be performed in any sequence and/or in any combination, and (ii) the components of respective embodiments may be combined in any manner.

Although the subject matter has been described in language specific to structural features and/or acts, it is to be understood that the subject matter defined in the appended claims is not necessarily limited to the specific features or acts described herein. Rather, the specific features and acts described herein are disclosed as examples of implementing the claims, and other equivalent features and acts are intended to be within the scope of the claims.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Unless the context clearly requires otherwise, throughout the description and the claims, the words “comprise,” “comprising,” and the like are to be construed in an inclusive sense, as opposed to an exclusive or exhaustive sense, e.g., in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words using the singular or plural number may also include the plural or singular number respectively. The word “or” in reference to a list of two or more items, covers all of the following interpretations of the word: any one of the items in the list, all of the items in the list, and any combination of the items in the list. Likewise the term “and/or” in reference to a list of two or more items, covers all of the following interpretations of the word: any one of the items in the list, all of the items in the list, and any combination of the items in the list.

Conjunctive language such as the phrase “at least one of X, Y and Z,” unless specifically stated otherwise, is otherwise understood with the context as used in general to convey that an item, term, etc. may be either X, Y or Z, or any combination thereof. Thus, such conjunctive language is not generally intended to imply that certain embodiments require at least one of X, at least one of Y and at least one of Z to each be present. Further, use of the phrase “at least one of X, Y or Z” as used in general is to convey that an item, term, etc. may be either X, Y or Z, or any combination thereof.

In some embodiments, certain operations, acts, events, or functions of any of the algorithms described herein can be performed in a different sequence, can be added, merged, or left out altogether (e.g., not all are necessary for the practice of the algorithms). In certain embodiments, operations, acts, functions, or events can be performed concurrently, e.g., through multi-threaded processing, interrupt processing, or multiple processors or processor cores or on other parallel architectures, rather than sequentially.

Embodiments are also described herein with reference to flow chart illustrations and/or block diagrams of methods, apparatus (systems) and computer program products. Each block of the flow chart illustrations and/or block diagrams, and combinations of blocks in the flow chart illustrations and/or block diagrams, may be implemented by computer program instructions. Such instructions may be provided to a processor of a general purpose computer, special purpose computer, specially-equipped computer (e.g., comprising a high-performance database server, a graphics subsystem, etc.) or other programmable data processing apparatus to produce a machine, such that the instructions, which execute via the processor(s) of the computer or other programmable data processing apparatus, create means for implementing the acts specified in the flow chart and/or block diagram block or blocks. These computer program instructions may also be stored in a non-transitory computer-readable memory that can direct a processor or other programmable data processing apparatus to operate in a particular manner, such that the instructions stored in the computer-readable memory produce an article of manufacture including instruction means which implement the acts specified in the flow chart and/or block diagram block or blocks. The computer program instructions may also be loaded to a computing device or other programmable data processing apparatus to cause operations to be performed on the computing device or other programmable apparatus to produce a computer implemented process such that the instructions which execute on the computing device or other programmable apparatus provide steps for implementing the acts specified in the flow chart and/or block diagram block or blocks.

Any patents and applications and other references noted above, including any that may be listed in accompanying filing papers, are incorporated herein by reference. Aspects of the invention can be modified, if necessary, to employ the systems, functions, and concepts of the various references described herein to provide yet further implementations of the invention. These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

To reduce the number of claims, certain aspects of the invention are presented below in certain claim forms, but the applicant contemplates other aspects of the invention in any number of claim forms. Any claims intended to be treated under 35 U.S.C. § 112(f) will begin with the words “means for,” but use of the term “for” in any other context is not intended to invoke treatment under 35 U.S.C. § 112(f). Accordingly, the applicant reserves the right to pursue additional claims after filing this application, in either this application or in a continuing application.

### Example Clauses

Various additional example embodiments of the disclosure can be described by the following clauses:

Clause 1. A method, comprising: receiving an encrypted bitstream, wherein the encrypted bitstream is associated with a reconfigurable logic device; generating a first hashed bitstream based in least in part one the encrypted bitstream and a first hash function; generating a second hashed bitstream based in least in part one the encrypted bitstream and a second hash function; generating a random number generator input for a random number generator based at least in part on the first hashed bitstream; generating a pool of random bits based at least in part on the second hashed bitstream and a random number generator output from the random number generator, wherein the random number generator output is based least in part on the random number generator input; generating a split key based at least in part on a subset of bits of the pool of random bits and a bitstream encryption key, wherein the bitstream encryption key is configured to be used to decrypt the encrypted bitstream; and storing a version of the split key in non-volatile memory, wherein the stored version of the split key is configured for use to recreate the bitstream encryption key.

Clause 2. The method of clause 1, wherein generating the random number generator input comprises generating the random number generator input for the random number generator using the first hashed bitstream and a reconfigurable logic device fingerprint.

Clause 3. The method of clause 2, wherein reconfigurable logic device fingerprint is generated based on hardware measurements of the reconfigurable logic device.

Clause 4. The method of clause 2, wherein generating the random number generator input comprises generating the random number generator input for the random number generator using the first hashed bitstream, the reconfigurable logic device fingerprint, and a random number generator input key.

Clause 5. The method of clause 4, wherein generating the random number generator input comprises generating the random number generator input for the random number generator by performing an exclusive or on the first hashed bitstream, the reconfigurable logic device fingerprint, and the random number generator input key.

Clause 6. The method of clause 4, wherein the random number generator input key is generated using the reconfigurable logic device fingerprint, the first hashed bitstream and a physically unclonable function output.

Clause 7. The method of clause 1, wherein generating the random number generator input comprises generating the random number generator input for the random number generator using the first hashed bitstream and a random number generator input key.

Clause 8. The method of clause 1, wherein the pool of random bits is the random number generator output.

Clause 9. The method of clause 1, wherein generating the pool of random bits comprises generating the pool of random bits based at least in part on the second hashed bitstream, the random number generator output, and a reconfigurable logic device fingerprint.

Clause 10. The method of clause 9, wherein generating the pool of random bits comprises generating the pool of random bits by performing an exclusive or on the second hashed bitstream, the random number generator output, and the reconfigurable logic device fingerprint.

Clause 11. The method of clause 10, wherein generating the pool of random bits comprises: generating a hash-based message authentication code input using the random number generator output, and the reconfigurable logic device fingerprint; generating a hash-based message authentication code output using the hash-based message authentication code input and the second hashed bitstream; and using the hash-based message authentication code output as the pool of random bits.

Clause 12. The method of clause 1, wherein generating the split key comprises generating the split key by performing an exclusive or on the subset of bits of the pool of random bits and the bitstream encryption key.

Clause 13. The method of clause 1, wherein storing the version of the split key in non-volatile memory, comprises storing the split key in non-volatile memory.

Clause 14. The method of clause 1, wherein the subset of bits is a first subset of bits, wherein storing the version of the split key in non-volatile memory, comprises: encrypting the split key using a second subset of bits of the of the pool of random bits; and storing the encrypted split key in the non-volatile memory.

Clause 15. The method of clause 1, wherein the first subset of bits and the bitstream encryption key have a same length.

Clause 16. A system, comprising: at least one processor; and non-transitory computer-readable medium storing instructions that, when executed by the at least one processor, cause the at least one processor to perform operations comprising: receive an encrypted bitstream, wherein the encrypted bitstream is associated with a reconfigurable logic device; generate a first hashed bitstream based in least in part one the encrypted bitstream and a first hash function; generate a second hashed bitstream based in least in part one the encrypted bitstream and a second hash function; generate a random number generator input for a random number generator based at least in part on the first hashed bitstream; generate a pool of random bits based at least in part on the second hashed bitstream and a random number generator output from the random number generator, wherein the random number generator output is based least in part on the random number generator input; generate a split key based at least in part on a subset of bits of the pool of random bits and a bitstream encryption key, wherein the bitstream encryption key is configured to be used to decrypt the encrypted bitstream; and store a version of the split key in non-volatile memory, wherein the stored version of the split key is configured for use to recreate the bitstream encryption key.

Clause 17. The system of clause 16, wherein generating the random number generator input comprises generating the random number generator input for the random number generator using the first hashed bitstream and a reconfigurable logic device fingerprint.

Clause 18. The system of clause 17, wherein reconfigurable logic device fingerprint is generated based on hardware measurements of the reconfigurable logic device.

Clause 19. The system of clause 17, wherein generating the random number generator input comprises generating the random number generator input for the random number generator using the first hashed bitstream, the reconfigurable logic device fingerprint, and a random number generator input key.

Clause 20. A non-transitory computer readable medium comprising instructions stored thereon that, when executed by at least one processor, cause the at least one processor to carry out operations comprising: receiving an encrypted bitstream, wherein the encrypted bitstream is associated with a reconfigurable logic device; generating a first hashed bitstream based in least in part one the encrypted bitstream and a first hash function; generating a second hashed bitstream based in least in part one the encrypted bitstream and a second hash function; generating a random number generator input for a random number generator based at least in part on the first hashed bitstream; generating a pool of random bits based at least in part on the second hashed bitstream and a random number generator output from the random number generator, wherein the random number generator output is based least in part on the random number generator input; generating a split key based at least in part on a set of bits of the pool of random bits and a bitstream encryption key, wherein the bitstream encryption key is configured to be used to decrypt the encrypted bitstream; and storing a version of the split key in non-volatile memory, wherein the stored version of the split key is configured for use to recreate the bitstream encryption key.

Clause 21. A method, comprising: receiving an encrypted bitstream, wherein the encrypted bitstream is associated with a reconfigurable logic device; generating a first hashed bitstream based in least in part one the encrypted bitstream and a first hash function; generating a second hashed bitstream based in least in part one the encrypted bitstream and a second hash function; generating a random number generator input for a random number generator based at least in part on the first hashed bitstream; generating a pool of random bits based at least in part on the second hashed bitstream and a random number generator output from the random number generator, wherein the random number generator output is based least in part on the random number generator input; generating a bitstream encryption key based at least in part on a set of bits of the pool of random bits; and decrypting the encrypted bitstream using the bitstream encryption key.

Clause 22. The method of clause 21, wherein generating the bitstream encryption key comprises generating the bitstream encryption key using the set of bits of the pool of random bits and a split key.

Clause 23. The method of clause 22, wherein the first set of bits and the split key have a same length.

Clause 24. The method of clause 22, wherein generating the bitstream encryption key comprises generating the bitstream encryption key by performing an exclusive or on the set of bits of the pool of random bits and a split key.

Clause 25. The method of clause 22, wherein the set of bits is a first set of bits, wherein generating the bitstream encryption key comprises: decrypting the split key using a second set of bits of the of the pool of random bits; and generating the bitstream encryption key using the set of bits and the decrypted split key.

Clause 26. The method of clause 25, wherein generating the bitstream encryption key using the set of bits and the decrypted split key comprises generating the bitstream encryption key by performing an exclusive or on the set of bits and the decrypted split key.

Clause 27. The method of clause 21, wherein the first hash function and the second hash function are distinct hash functions.

Clause 28. A system, comprising: at least one processor; and non-transitory computer-readable medium storing instructions that, when executed by the at least one processor, cause the at least one processor to perform operations comprising: receive an encrypted bitstream, wherein the encrypted bitstream is associated with a reconfigurable logic device; generate a first hashed bitstream based in least in part one the encrypted bitstream and a first hash function; generate a second hashed bitstream based in least in part one the encrypted bitstream and a second hash function; generate a random number generator input for a random number generator based at least in part on the first hashed bitstream; generate a pool of random bits based at least in part on the second hashed bitstream and a random number generator output from the random number generator, wherein the random number generator output is based least in part on the random number generator input; generate a bitstream encryption key based at least in part on a set of bits of the pool of random bits; and decrypt the encrypted bitstream using the bitstream encryption key.

Clause 29. The system of clause 28, wherein generating the bitstream encryption key comprises generating the bitstream encryption key using the set of bits of the pool of random bits and a split key.

Clause 30. The system of clause 29, wherein the first set of bits and the split key have a same length.

Clause 31. The system of clause 29, wherein generating the bitstream encryption key comprises generating the bitstream encryption key by performing an exclusive or on the set of bits of the pool of random bits and a split key.

Clause 32. The system of clause 29, wherein the set of bits is a first set of bits, wherein generating the bitstream encryption key comprises: decrypting the split key using a second set of bits of the of the pool of random bits; and generating the bitstream encryption key using the set of bits and the decrypted split key.

Clause 33. The system of clause 32, wherein generating the bitstream encryption key using the set of bits and the decrypted split key comprises generating the bitstream encryption key by performing an exclusive or on the set of bits and the decrypted split key.

Clause 34. The system of clause 28, wherein the first hash function and the second hash function are distinct hash functions.

Clause 35. A non-transitory computer readable medium comprising instructions stored thereon that, when executed by at least one processor, cause the at least one processor to carry out operations comprising: receiving an encrypted bitstream, wherein the encrypted bitstream is associated with a reconfigurable logic device; generating a first hashed bitstream based in least in part one the encrypted bitstream and a first hash function; generating a second hashed bitstream based in least in part one the encrypted bitstream and a second hash function; generating a random number generator input for a random number generator based at least in part on the first hashed bitstream; generating a pool of random bits based at least in part on the second hashed bitstream and a random number generator output from the random number generator, wherein the random number generator output is based least in part on the random number generator input; generating a bitstream encryption key based at least in part on a set of bits of the pool of random bits; and decrypting the encrypted bitstream using the bitstream encryption key.

Clause 36. The non-transitory computer readable medium of clause 35, wherein generating the bitstream encryption key comprises generating the bitstream encryption key using the set of bits of the pool of random bits and a split key.

Clause 37. The non-transitory computer readable medium of clause 36, wherein the first set of bits and the split key have a same length.

Clause 38. The non-transitory computer readable medium of clause 36, wherein generating the bitstream encryption key comprises generating the bitstream encryption key by performing an exclusive or on the set of bits of the pool of random bits and a split key.

Clause 39. The non-transitory computer readable medium of clause 36, wherein the set of bits is a first set of bits, wherein generating the bitstream encryption key comprises: decrypting the split key using a second set of bits of the of the pool of random bits; and generating the bitstream encryption key using the set of bits and the decrypted split key.

Clause 40. The non-transitory computer readable medium of clause 39, wherein generating the bitstream encryption key using the set of bits and the decrypted split key comprises generating the bitstream encryption key by performing an exclusive or on the set of bits and the decrypted split key.

Clause 41. A method, comprising: receiving an encrypted bitstream, wherein the encrypted bitstream is associated with a reconfigurable logic device; generating a first hashed bitstream based in least in part one the encrypted bitstream and a first hash function; generating a random number generator input for a random number generator based at least in part on the first hashed bitstream; generating a random number generator input key based at least in part on the first hashed bitstream, the random number generating input, and reconfigurable logic device bitstream measurements; and storing the random number generator input key in non-volatile memory.

What is claimed is:

1. A method, comprising:
receiving an encrypted bitstream, wherein the encrypted bitstream is associated with a reconfigurable logic device;
generating a first hashed bitstream based in least in part one the encrypted bitstream and a first hash function;
generating a second hashed bitstream based in least in part one the encrypted bitstream and a second hash function;
generating a random number generator input for a random number generator based at least in part on the first hashed bitstream;
generating a pool of random bits based at least in part on the second hashed bitstream and a random number generator output from the random number generator, wherein the random number generator output is based least in part on the random number generator input;
generating a split key based at least in part on a subset of bits of the pool of random bits and a bitstream encryption key, wherein the bitstream encryption key is configured to be used to decrypt the encrypted bitstream; and
storing a version of the split key in non-volatile memory, wherein the stored version of the split key is configured for use to recreate the bitstream encryption key.

2. The method of claim 1, wherein generating the random number generator input comprises generating the random number generator input for the random number generator using the first hashed bitstream and a reconfigurable logic device fingerprint.

3. The method of claim 2, wherein reconfigurable logic device fingerprint is generated based on hardware measurements of the reconfigurable logic device.

4. The method of claim 2, wherein generating the random number generator input comprises generating the random number generator input for the random number generator using the first hashed bitstream, the reconfigurable logic device fingerprint, and a random number generator input key.

5. The method of claim 4, wherein generating the random number generator input comprises generating the random number generator input for the random number generator by performing an exclusive or on the first hashed bitstream, the reconfigurable logic device fingerprint, and the random number generator input key.

6. The method of claim 4, wherein the random number generator input key is generated using the reconfigurable logic device fingerprint, the first hashed bitstream and a physically unclonable function output.

7. The method of claim 1, wherein generating the random number generator input comprises generating the random number generator input for the random number generator using the first hashed bitstream and a random number generator input key.

8. The method of claim 1, wherein the pool of random bits is the random number generator output.

9. The method of claim 1, wherein generating the pool of random bits comprises generating the pool of random bits based at least in part on the second hashed bitstream, the random number generator output, and a reconfigurable logic device fingerprint.

10. The method of claim 9, wherein generating the pool of random bits comprises generating the pool of random bits by performing an exclusive or on the second hashed bitstream, the random number generator output, and the reconfigurable logic device fingerprint.

11. The method of claim 10, wherein generating the pool of random bits comprises:
generating a hash-based message authentication code input using the random number generator output, and the reconfigurable logic device fingerprint;
generating a hash-based message authentication code output using the hash-based message authentication code input and the second hashed bitstream; and
using the hash-based message authentication code output as the pool of random bits.

12. The method of claim 1, wherein generating the split key comprises generating the split key by performing an exclusive or on the subset of bits of the pool of random bits and the bitstream encryption key.

13. The method of claim 1, wherein storing the version of the split key in non-volatile memory, comprises storing the split key in non-volatile memory.

14. The method of claim 1, wherein the subset of bits is a first subset of bits, wherein storing the version of the split key in non-volatile memory, comprises:
encrypting the split key using a second subset of bits of the of the pool of random bits; and
storing the encrypted split key in the non-volatile memory.

15. The method of claim 1, wherein the first subset of bits and the bitstream encryption key have a same length.

16. A method, comprising:
receiving an encrypted bitstream, wherein the encrypted bitstream is associated with a reconfigurable logic device;
generating a first hashed bitstream based in least in part one the encrypted bitstream and a first hash function;
generating a second hashed bitstream based in least in part one the encrypted bitstream and a second hash function;
generating a random number generator input for a random number generator based at least in part on the first hashed bitstream;
generating a pool of random bits based at least in part on the second hashed bitstream and a random number generator output from the random number generator, wherein the random number generator output is based least in part on the random number generator input;
generating a bitstream encryption key based at least in part on a set of bits of the pool of random bits; and
decrypting the encrypted bitstream using the bitstream encryption key.

17. The method of claim 16, wherein generating the bitstream encryption key comprises generating the bitstream encryption key using the set of bits of the pool of random bits and a split key.

18. The method of claim 17, wherein the first set of bits and the split key have a same length.

19. The method of claim 17, wherein generating the bitstream encryption key comprises generating the bitstream encryption key by performing an exclusive or on the set of bits of the pool of random bits and a split key.

20. A method, comprising:
receiving an encrypted bitstream, wherein the encrypted bitstream is associated with a reconfigurable logic device;
generating a first hashed bitstream based in least in part one the encrypted bitstream and a first hash function;
generating a random number generator input for a random number generator based at least in part on the first hashed bitstream;
generating a random number generator input key based at least in part on the first hashed bitstream, the random number generating input, and reconfigurable logic device bitstream measurements; and
storing the random number generator input key in non-volatile memory.
